(19) United States
(12) Patent Application Publication
(10) Pub. No.: US 2011/0238504 A1
(43) Pub. Date: Sep. 29, 2011

(54) System And Method For Modifying Advertising Costs Based On The Visibility Of The Advertisement

(76) Inventors: Nazish Aslam, Edinburgh (GB); Mark Muir, Edinburgh (GB)

(21) Appl. No.: 13/072,735

(22) Filed: Mar. 27, 2011

Related U.S. Application Data
(60) Provisional application No. 61/317,748, filed on Mar. 26, 2010.

(51) Int. Cl. G06Q 30/00

(52) U.S. Cl. 705/14.69

(57) ABSTRACT

The cost of advertisements, for example advertisements on the Internet, is based on the “visibility” of the advertisements. The visibility is determined by considering at least the following factors: the duration the advertisement is displayed, the geographical expanse the advertisement is displayed to, the broadness of the search terms associated with the advertisement and whether the advertisement is given premium placement.

### CROSS REFERENCE TO RELATED APPLICATIONS

The present application claims priority to Provisional Patent Application No. 61/317,748, filed Mar. 26, 2010 entitled “Method for Calculating Cost Based on Visibility” which is incorporated herein in its entirety, and the benefit of the earlier Mar. 26, 2010 filing date is claimed in accordance with 35 U.S.C. §119 (e)(1).

### TECHNICAL FIELD

The present invention generally relates to information, such as advertisements, disseminated over networked computers, such as the Internet, and more specifically to determining the appropriate fees for the dissemination of the information based on the visibility of the information.

### BACKGROUND OF THE INVENTION

Companies and individuals that advertise (“advertisers”) their products and/or services over the Internet are familiar with the utility of the Internet to inform consumers of the products and/or services of the advertiser. It is generally believed that increasing the number of visits or “hits” on an advertiser's website, will increase the number of sales of the advertiser's products or services. Routinely, a potential purchaser searching for a specific product or service over the Internet will run one or more searches using at least one keyword to identify information on a specific product or service available over the Internet. At the conclusion of each of these searches the potential purchaser is presented with the search results which are generally presented as a list of links to the uniform resource locators (URLs) in which the keyword (or keywords) appear. In addition, the potential purchaser is normally presented with a subsection of the text surrounding the keyword(s) contained at the URL thereby giving the potential purchaser an insight into the context the keyword(s) are used at the associated URLs. The potential purchaser may then “click through” to any of the displayed URLs to visit the website which contained the keyword(s) or may perform additional searches to further identify websites of interest.

Keyword searches may result in the identification of literally thousands of links to websites which contain the keyword(s). Understandably, the potential purchaser does not have the time nor the interest to review each of the websites associated with the links contained in the search results. For an individual or company to successfully advertise its product or service over the Internet, it is critical that the link to its website be prominently displayed to potential purchasers that have the interest and the ability to purchase the advertiser's goods or services.

While advertisers are willing to pay for visitors to be directed to their websites, they are willing to pay more for website visitors that have a higher likelihood of purchasing the goods and/or services offered by the advertiser.

Accordingly, there is a need for a system and method that matches the cost of the advertisement with the effectiveness of the Internet advertisement. In addition, there is a need for a system and method which permits smaller business to compete fairly for valuable advertising space with larger businesses.

### SUMMARY OF THE INVENTION

One embodiment of the invention includes a method of determining a cost of an advertisement based on a visibility of the advertisement comprising: determining an expected duration of the advertisement; determining a geographical expanse of the advertisement; determining a broadness of the advertisement; and using a processor to determine the cost of the advertisement wherein the cost of the advertisement is dependent on the expected duration of the advertisement, the geographical expanse of the advertisements, and the broadness of the advertisement.

Another embodiment of the invention includes a computer system for determining the cost of an advertisement including: at least one input device for a user to provide an expected duration of the advertisement, a geographical expanse of the advertisement, and a broadness of the advertisement; a computer display for the computer system to display information to the user; and a processor which calculates a cost of the advertisement based on the expected duration of the advertisement, the geographical expanse of the advertisement, and the broadness of the advertisement.

### BRIEF DESCRIPTION OF THE DRAWINGS

The drawings are meant to illustrate the principles of the invention and do not limit the scope of the invention. The above-mentioned features and objects of the present disclosure will become more apparent with reference to the following description taken in conjunction with the accompanying drawings wherein like reference numerals denote like elements in which:

FIG. 1 shows the various constituent components of visibility;

FIG. 2 illustrates a graph with duration as the x-axis and cost factor as the y-axis; and

FIG. 3 shows a representative computer system that may be used to calculate the cost of advertisements.

### DETAILED DESCRIPTION OF THE INVENTION

Reference will now be made in detail to the exemplary embodiments of the present disclosure, examples of which are illustrated in the accompanying drawings, wherein like reference numerals refer to like elements throughout. The embodiments are described below so as to explain the present disclosure by referring to the figures. Repetitive description with respect to like elements of different exemplary embodiments may be omitted for the convenience of clarity.

Ideally, the cost of advertising a product or service should be “results based”, meaning the fee the advertiser pays for the advertisements should be based on the number of sales, or customers, resulting from the advertisement itself. Various mechanisms have been devised over the years to approximate a “results based” system. However, it is difficult to implement an effective “results based” system for advertisements displayed and viewed over the Internet. Instead, advertisement fees are generally based on the number of visitors directed to a website, or the number of people who “click through” one website to the advertiser's website. These advertisement fees are lacking in that not everyone who clicks through a website is interested in purchasing the product or service offered by the advertiser. Embodiments of the present invention permit a better correlation between the cost of an advertisement and the effectiveness of the advertisement. In one embodiment of the present invention, highly customized payment charges for the advertisement is based on several weighting factors, which together constitute the “visibility” of the advertisement. Embodiments of the present invention assign a cost to each person that could potentially see the offer. The number of people targeted to see the offer or advertisement is used to determine the cost of the advertisement.

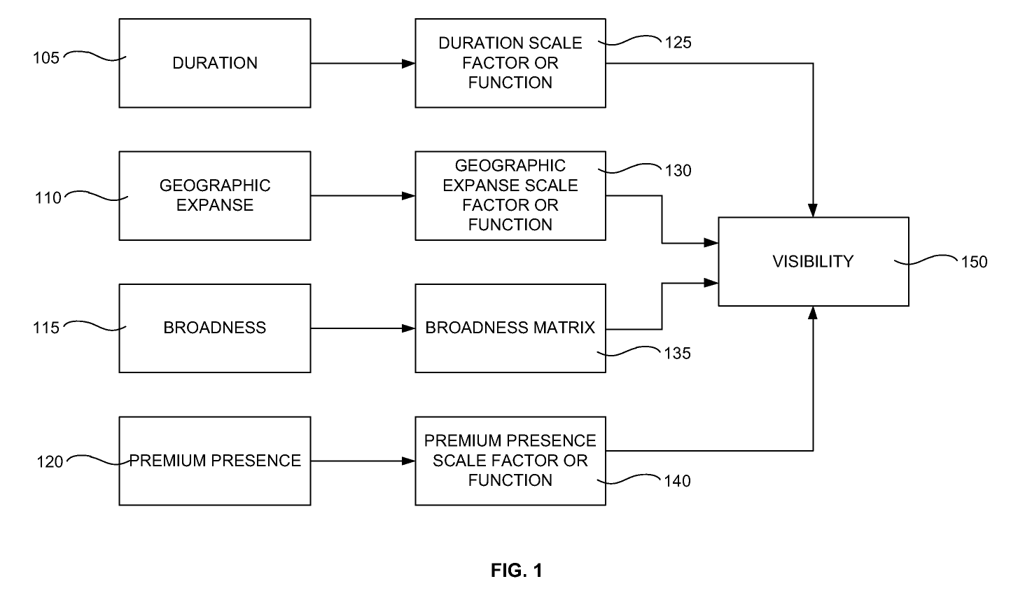

As illustrated in FIG. 1, factors which affect the visibility of the advertisement, include, but are not limited to, A) the duration 105 of the advertisement, B) the geographical expanse 110 the advertisement is visible to, C) the broadness 115 of the search terms associated with the advertisement, and D) whether the advertisement has premium presence 120. Each of these components will be explained in detail and representative examples will be provided to further explain each component.

Duration 105 refers to the length of time the advertisement remains visible online. Generally, the longer the information remains online, the more visibility it receives. In a preferred embodiment, duration is combined with the anticipated number of Internet users online at various times of the day and/or the year. For example, an advertisement available during a peak Internet time of the day would be expected to have more visits than an advertisement displayed during a non-peak Internet time. In a preferred embodiment, the duration of the advertisement and the expected number of Internet users online during the time the advertisement is displayed are combined.

Understandably, the cost of an advertisement should be adjusted according to how long the advertisement is visible for, or how long a subscription for the advertisement is to last. Typically, shorter duration advertisements would cost less than longer duration advertisements.

In one embodiment of the present invention, it may be an option to use a linear relationship between the time the advertisement is displayed and its cost. In other words, the cost of the advertisement is directly proportional to the duration of the advertisement, i.e.,

duration_factor=a_{—}d; where a_{—}d is a constant value.

However, applying a straight linear time factor for calculating advertisement costs may result in the cost of very short-lived advertisements (e.g. 2 hours) to be almost negligible, or instead if the linear time factor is adjusted to behave more realistically for short-lived advertisements, the cost for longer-term advertisements can become extortionate.

To address this, an arbitrary curve can be applied to the duration of the advertisement. This curve may be a continuous function of time, or a discrete approximation.

duration_factor=f(t)

As a simple example, the cost of very short-lived advertisement could be properly determined by scaling up the ‘cost per unit time’ for the first few hours, using a function such as the following:

f(t)=H(t−0)(t−0)b1+H(t−t1)(t−t1)(b2−b1)+H(t−t2)(t−t2)(b3−b2)

Where H( ) is the Heaviside unit step function: H(x)=(x<0) ? 0:1, and t represents duration. t* are various thresholds, each having their own corresponding scaling factor (b*). The duration, t, may be split into bins, with consecutive thresholds defining the start and end of each bin. Effectively, each time unit may have a single factor applied to it. While three bins are depicted in the above example, one of ordinary skill in the art would appreciate that any number could be used. Duration scale factor or function 125 of FIG. 1 illustrates how a scale factor or a function can be used to adjust the impact duration has on the cost of the advertisement.

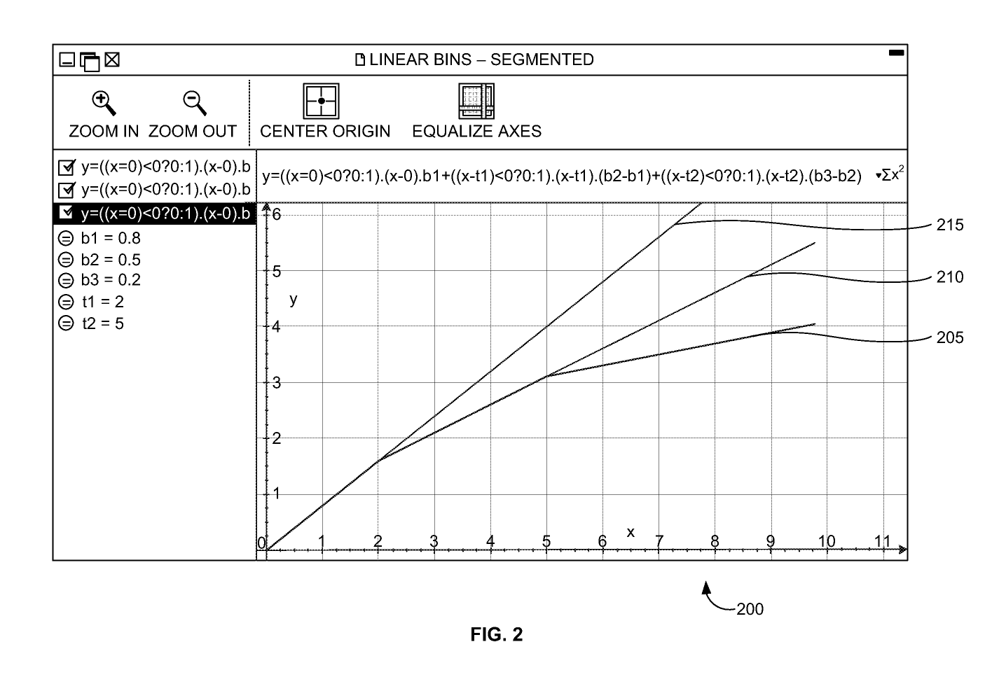

FIG. 2 illustrates a graph with duration as the x-axis and cost factor as the y-axis for the above given equation, assuming three bins. In this example, short durations (0<=t<t1) are charged a premium, with medium durations (t1<=t<t2) charged at a lower relative rate, and long durations (t>=t2) charged at a further reduced rate. Line 205 show the effect when each of the reduced rates are available and applied. The duller lines on the graph of FIG. 2 (210 and 215) show the effect of the previous line continuing had the extra bin not come into effect. One way the choice of curve to apply may be determined by modeling some acceptable cost points for various sample durations. An approximate curve may be constructed by joining such cost points together and mathematically describing the resultant curve, by means of a polynomial equation (using any number of degrees as appropriate) or equivalent. A continuous curve may describe the desired algorithm behavior more accurately but would be significantly more compute-intensive compared to a discrete approximation. Such a discrete curve may be computed on the fly each time a cost is to be calculated, or a Look-Up Table may be used instead.

The geographical expanse 110 of FIG. 1, relates to the geographical area the advertisement will be available within. The geographical expanse can be based on the number of people targeted, for example based on a “high-population” zip codes. A local advertiser who sells perishable goods may desire a small geographical expanse, while a national advertiser selling a durable good may desire that its advertisement be made available across the nation or even internationally. Generally, the more people in the area targeted, the more visibility the information achieves.

Similar to how a suitable arbitrary curve may be determined for the duration factor calculation, the linear scaling factor for the geographical expanse may be largely determined by the upper-end: in other words, the linear scaling factor has to be selected to make sure that targeting large expanses (such as an entire country) is affordable (e.g. similar to other existing methods of targeting wide audiences). However, this leads to very low pricing for small geographical expanses.

Alternatively, a premium could be applied for advertisements displayed to smaller geographical expanses where the cost of the overall advertisement still remains lower than an advertisement that is displayed to a larger geographical area. This would allow the advertiser that is targeting a smaller geographical expanse to still save money, while allowing advertisements to smaller geographical expanses be sustainable.

In other embodiments, a non-linear weighting function may be applied to the geographical expanse instead, artificially increasing the ‘cost per unit of expanse’ factor for smaller expanses (or decreasing the ‘cost per unit of expanse’ for larger expanses); similar to that used for time. expanse_factor=f(e) where ‘e’ is the geographic expanse being targeted. In one embodiment, the geographic expanse may be recorded by zip codes, or alternatively it may be recorded as individual user IDs which represent people in a given geographic area. If zip codes are used, various zip codes may be assigned different weighting factors to reflect the characteristics of each. Such as a given zip code with high density of population would be assigned a higher weighting versus another zip code with relatively less.

$$fe = {\sum }_{i = 0}^{e} w [ i ]$$

where ‘e’ is the geographic expanse and ‘w’ is an array associating a perceived weight (value) to each item of the geographic expanse, such as the zip codes. If all zip codes are assumed to have an equal weighting, then w[i]=1 for all zip codes. Geographic Expanse scale factor or function 130 of FIG. 1 illustrates how a scale factor or a function can be used to adjust the impact geographic expanse has on the overall cost of the advertisement.

Broadness 115 of FIG. 1, refers to the search criteria under which the advertisement appears. For example, in keyword searches, as the number of keywords associated with the advertisement increases (i.e., the broadness increases), the more keyword searches the advertisement will be responsive to. There is a direct relationship between broadness and visibility, meaning that as broadness increases, so does the visibility of the information. The number of categories a business wants to be listed under can impact how often advertisements pertaining to that business appears in such results or listings, thereby contributing to the visibility of the advertiser. In a preferred embodiment, the use of the broadness factor is also used to calculate the cost of the advertisement.

The broadness factor may be calculated to be directly proportional to the number of keywords or categories selected through which the business may appear in search results or listings, or it may be a function of these various keywords and/or categories, where each of these keywords and/or categories have a different weighting associated with them, based on their perceived value (e.g. how common they are as search keywords).

broadness_factor=f(c)

where

$$fc = {\sum }_{i = 0}^{c} w [ i ]$$

Where ‘c’ is the categories and ‘w’ is an array 135 associating a perceived weight (value) to each category known to the system. Any number of categories may be used. If all categories are considered to be of equal value, then w[i]=1 for all categories. The categories may be indexed arbitrarily as their ordering is not important in the given example equation.

Premium presence 120 of FIG. 1, measures enhanced visibility of the advertisement through favorable placement relative to other advertisements matching the same search criteria. One example of a premium placement is for the link of the advertiser to be ranked higher in the search results.

The cost associated with premium placement may be a predetermined cost added on top of the overall cost of the advertisement, or it may be a linear scaling factor to be applied to the costs already calculated using the previous visibility metrics.

premium_factor=a_{—}p

where a_p is a constant.

Premium presence scale factor or function 140 of FIG. 1 illustrates how a scale factor or a function can be used to adjust the impact premium presence has on the cost of the advertisement.

In a preferred embodiment, the system of adjusting the cost of the advertisement based on its visibility is ‘predictive,’ meaning that the costs are known in advance, rather than be determined as a result of user behavior. Thus far the various visibility factors have been discussed in a standalone manner. In a preferred embodiment of the present invention, the various visibility metrics are quantified and linked together to produce an overall cost. While one way is presented below, one of ordinary skill in the art would understand that other ways are within the scope of the invention.

In one embodiment, the base units for each of these metrics are transformed into visibility by arbitrary equations. These equations can be finely tuned by the system operator to most closely match visibility to people, based on continuous feedback. This allows the system to effectively reduce spam, by artificially increasing the cost of components that are more likely to target people who are uninterested in the information being disseminated.

As described below, the various individual visibility factors may be combined to create a unified costing system based on visibility.

The various visibility factors may either:
Technique 1: be added together to produce an overall visibility factor (v), where each metric may have a relative weighting of how much influence it could have versus the other metrics. In this embodiment the cost calculation would thereafter use the overall visibility factor (v) as a pricing coefficient, final cost=normal cost×v, or
Technique 2: be multiplied together and impact the overall price by being applied as unit-less scaling factors of cost, where some base value for cost is scaled appropriately by one or more of these visibility factors, or
use a combination of the above two techniques.

Technique 1—A Weighted Sum of Each of the Visibility Factors

cost=unit_duration_base_cost*(duration_factor*d)+unit_expanse_base_cost*(expanse_factor*e)+unit_broadness_base_cost*(broadness_factor*b)+unit_premuim_base_cost*(premium_factor*p)

Where ‘d’ represents the duration of the advertisement, ‘e’ represents the geographic expanse, ‘b’ represents the broadness of the advertisement and ‘p’ represents any premium presence for the advertisement. The various*_factor may be derived as discussed above.

Such a technique may be used to directly control how much influence a given visibility factor may have on the final price by varying the base cost values.

Technique 2—Unified Base Cost Metric

Specify a base cost per unit (all metrics), and multiply this by the product of the visibility factors. The relative influence of each metric can be adjusted by the scaling factor used inside each visibility factor function.

cost=unit_base_cost*(duration_factor*d)*(expanse_factor*e)*(broadness_factor*b)*(premium_factor*p)

The non-linear scalings described above may be used to artificially adjust the overall cost so that the cost does not appear unreasonable (by being too high or too low for any given advertisement scenario). However, what constitutes too high or too low is subjective, and can differ according to which of the various visibility metrics are near their extremes. For instance, if non-linear weightings are used for duration and expanse to artificially increase the per-unit cost for small durations and small expanses respectively, and an announcement is made with both a small duration and small expanse, these weightings combine. This could result in the cost being increased to an amount above the subjectively reasonable value.

To address this, the weightings can be made to be interdependent—i.e. rather than each scaling factor being a function of a single independent variable (the corresponding metric), they can be made to depend on multiple (or all) metrics.

In one embodiment, one of the metrics may be identified as the ‘primary’ metric, and its corresponding visibility factor function may be made dependent on that metric alone. Next, each of the remaining visibility factor functions could be made dependent on both their own corresponding metric, plus the primary metric. The visibility factor functions of the non-primary metric may incorporate the inverse of the portion of the primary visibility factor, to allow the non-primary visibility factors' effect to be reduced when the primary visibility factor is dominant.

For example, the following pricing equation is given based on Technique 2 mentioned above. While this example uses two metrics, one of ordinary skill in the art would appreciate that additional metrics are within the scope of the invention.

cost=unit_base_cost*(duration_factor*d)*(expanse_factor*e)

Where ‘d’ represents duration of the advertisement and ‘e’ represents the geographic expanse.

A simple linear scaling may be implemented using the following metric scaling factors:

duration_factor=a_{—}d

expanse_factor=a_{—}e

Where a_* are constant (linear) scaling factors. To achieve a form of non-linear scaling, to artificially increase low values, these factors may be modified as follows:

duration_factor=a_{—}d+f_{—}d(d)

expanse_factor=a_{—}e+f_{—}e(e)

Where ‘d’ represents the duration and ‘e’ represents the geographic expanse of the advertisement.

A single threshold may be added, below which a higher scaling factor applies as follows:

f_{—}d(d)=H(t_{—}d−d)*b_{—}d/d

f_{—}e(e)=H(t_{—}e−e)*b_{—}e/e

Where t_* are constant threshold values, and b_* are constant sub-threshold scaling factors. These introduce a different gradient to the line below the threshold. To prevent the artificial increases from combining, cross-talk can be introduced and interdependencies created as follows. If we arbitrarily choose expanse as the primary metric, then we can rewrite the offset functions as follows:

f_{—}e(e)=H(t_{—}e−e)*b_{—}e/e

f_{—}d(d,e)=H(t_{—}d−d)*(b_{—}d/d)*(1/1+f_{—}e(e))

The more general form of this technique may allow any arbitrary ‘feel’ to be implemented, potentially allowing very careful tailoring of user behavior. Influencing user behavior is important in optimizing the system for improved relevance in search hits.

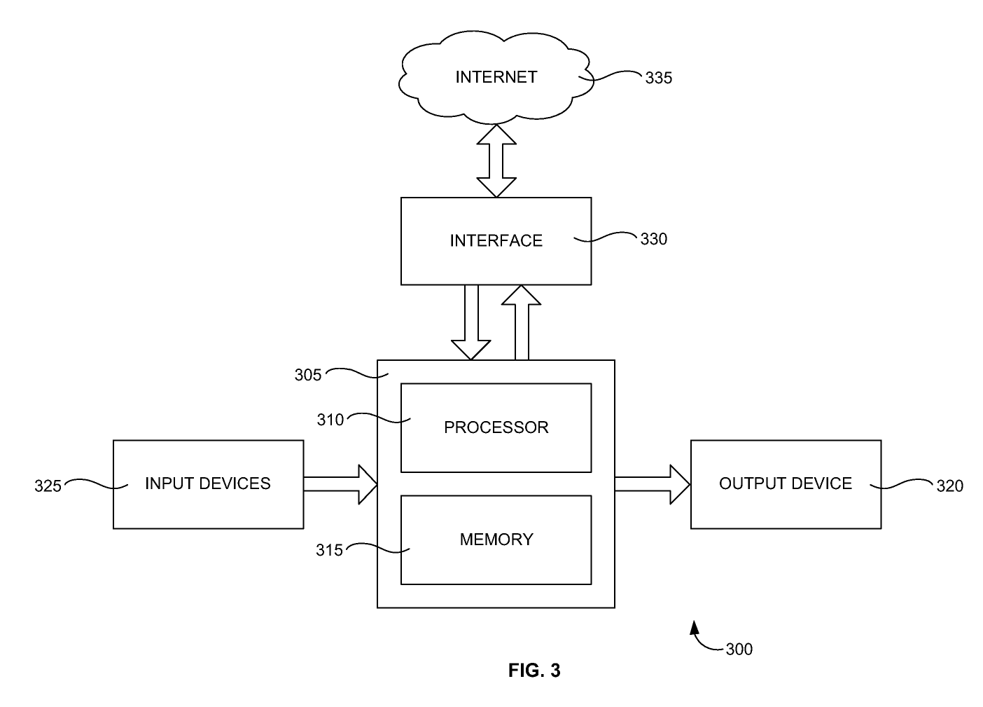

FIG. 3 shows a representative computer system 300 that may be used to calculate the cost of advertisements. Computer system 300 includes the computer 305 which houses a processor 310, memory 315, a computer display 320 as an output device, and input devices 325 such as a keyboard and a mouse. In addition, computer system 300 is connected to a network or the Internet 335 through an interface 330. The memory 315 of the computer system 300 may be used to store previously calculated costs along with the corresponding advertisements information. The processor 310 of the computer 305 may be used to analyze such stored data, e.g. to determine the cost versus the number of search hits. Such analysis results may be used to further improve the cost metrics and thereby alter the user behavior in a desirable manner, e.g. for the purpose of controlling and limiting undesirable behavior (such as spamming).

A small business example such as a local café can be used to demonstrate that this scheme yields an improvement in cost effectiveness over “pay-per-click” and other related advertising schemes for such a business type. With the proposed scheme, the café will not pay for people viewing their offer who cannot make use of it (e.g. by being outside of the target area). Additionally, the user gets more relevant hits, allowing them to identify the best deal with less effort. In an example scenario, the local café may experience a lack of traffic through its door on a given day for some reason such as off-peak hours, competing business offers, etc.

During an off-peak time (as determined by one embodiment of the invention), there will be (by definition) fewer people per unit of geographical area using the system. Therefore, to reach the same number of people, (for instance) a larger geographical area must be targeted. The visibility calculation reflects this, by allowing a wider geographical area to be targeted for the same duration, when the offer is placed during an off-peak time as opposed to a peak time, for a given cost. The decision making process for such widening or narrowing of the geographical expanse may be automated.

Alternatively, the café may decide to broaden the scope of its advertisement instead, or in addition to increasing the expanse, so that it is more likely to appear in results for those who may be searching for similar (but not necessarily exactly the same) category of items.

On the other hand, the café may choose to attract customers through a competitive offer with increased visibility via premium presence, in order to attract more attention. A premium presence causes the advertisement to appear higher in the search rankings than otherwise similar offers. Generally, a premium position will cause more people to view the offer and thus potentially make use of it. The increase in price associated with this premium presence could potentially take into account how many similar offers are present in the system (computed by various distance metrics), and thus be made to reflect the potential increase in viewers

While the present disclosure has been described with reference to the specific embodiments and examples thereof, it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present disclosure. All such modifications are intended to be within the scope of the claims appended hereto.

What is claimed is:

1. A method of determining a cost of an advertisement based on a visibility of the advertisement comprising:
determining an expected duration of the advertisement;
determining a geographical expanse of the advertisement;
determining a broadness of the advertisement; and
using a processor to determine the cost of the advertisement wherein said cost of the advertisement is dependent on the expected duration of the advertisement, the geographical expanse of the advertisements, and the broadness of the advertisement.

2. The method of claim 1 wherein a linear relationship exists between the cost of the advertisement and the expected duration of the advertisement.

3. The method of claim 1 wherein an arbitrary curve is used to determine the relationship between the cost of the advertisement and the expected duration of the advertisement.

4. The method of claim 1 wherein a scaling factor is used to increase the cost of the advertisement for advertisements of a short duration.

5. The method of claim 1 wherein a non-linear weighting function is used to determine the relationship between the cost of the advertisement and the geographical expanse of the advertisement.

6. The method of claim 1 wherein the broadness of the advertisement is determined by the number of keywords associated with the advertisement.

7. The method of claim 6 further comprising:
a matrix including at least one weighting factor for the keywords and the processor uses the at least one weighting factor to determine the cost of the advertisement.

8. The method of claim 1 further comprising:
determining by a processor a cost associated with a premium presence of the advertisement wherein the cost of the advertisement is based, in part, on the premium presence.

9. A computer system for determining the cost of an advertisement comprising:
at least one input device for a user to provide an expected duration of the advertisement, a geographical expanse of the advertisement, and a broadness of the advertisement;
a computer display for said computer system to display information to said user;
a processor which calculates a cost of the advertisement based on the expected duration of the advertisement, the geographical expanse of the advertisement, and the broadness of the advertisement.

10. The computer system of claim 9 wherein a linear relationship exists between the cost of the advertisement calculated by the processor and the expected duration of the advertisement.

11. The computer system of claim 9 wherein an arbitrary curve is used to determine the relationship between the cost of the advertisement calculated by the processor and the expected duration of the advertisement.

12. The computer system of claim 9 wherein a scaling factor is used to increase the cost of the advertisement calculated by the processor for advertisements of a short duration.

13. The computer system of claim 9 wherein a non-linear weighting function is used to determine the relationship between the cost of the advertisement calculated by the processor and the geographical expanse of the advertisement.

14. The computer system of claim 9 wherein the broadness of the advertisement is determined by the number of keywords associated with the advertisement.

15. The computer system of claim 14 further comprising:
a matrix including at least one weighting factor for the keywords and the processor uses the at least one weighting factor to determine the cost of the advertisement.

16. The computer system of claim 9 further comprising:
determining a cost associated with a premium presence of the advertisement wherein the cost of the advertisement calculated by the processor is based, in part, on the premium presence.

17. The computer system of claim 9 collecting information on previously calculated costs and the resulting number of search hits, for later analysis.

18. From the information gathered in claim 17, deriving relationships between the costing and resulting user behavior.

19. Using the relationship obtained from claim 18 to modify the cost metrics, to alter user behavior in a desired manner.
